(19) United States
(12) Patent Application Publication
(10) Pub. No.: US 2018/0208203 A1
(43) Pub. Date: Jul. 26, 2018

(54) SYSTEM, METHOD AND COMPUTER PROGRAM PRODUCT FOR BRAKING CONTROL WHEN APPROACHING A TRAFFIC SIGNAL

(71) Applicant: International Business Machines Corporation, Armonk, NY (US)

(72) Inventors: Michael S. Gordon, YORKTOWN HEIGHTS, NY (US); Stacy Fay Hobson, YORKTOWN HEIGHTS, NY (US); Ashish Kundu, YORKTOWN HEIGHTS, NY (US)

(73) Assignee: International Business Machines Corporation

(21) Appl. No.: 15/416,884

(22) Filed: Jan. 26, 2017

(51) Int. Cl. B60W 40/08; B60W 10/18; B60W 30/095

(52) U.S. Cl. CPC B60W 40/08; B60W 10/18; B60W 30/0956; B60W 2550/30; B60W 2540/22; B60W 2710/18; B60W 2040/0818

(57) ABSTRACT

A vehicle control method, system, and computer program product, includes determining a cognitive state of a driver of a vehicle, detecting an upcoming traffic signal at an intersection and a status of the upcoming traffic signal, identifying intersection data relating to the intersection with the upcoming traffic signal, and performing a vehicle control action on the vehicle at the intersection based on the cognitive state of the driver, the status of the upcoming traffic signal, and the intersection data.

### BACKGROUND

The present invention relates generally to a vehicle control method, and more particularly, but not by way of limitation, to a system, method, and computer program product for performing brake control based on whether a vehicle should proceed through an intersection or stop prior to entering the intersection.

Vehicles are becoming more advanced in the onboard systems and technologies they have available to increase safety during travel. Some of these vehicles are able to use sensors and other technologies to identify the vehicle's positioning, trajectory, speed, path, time remaining of an illuminated yellow traffic light (i.e., cautionary light), and objects in the vicinity to quickly assess the situation and the likelihood of an accident or other significant issue. In many cases, the vehicle can make this assessment faster and more accurately than a human.

More than twenty percent of traffic fatalities in the United States occur at intersections. Drivers are often basing their decision on incomplete or inaccurate information such as the estimated length of the intersection, the time it would take their vehicle to clear the intersection, the distance from the car's current position to the beginning of the intersection, and the remaining time for the traffic light to turn from an illuminated yellow to an illuminated red color. Thus, there is a need in the art for vehicle control (i.e., driver assistance) for decision-making near intersections.

### SUMMARY

In an exemplary embodiment, the present invention can provide a computer-implemented vehicle control method, the method including determining a cognitive state of a driver of a vehicle, detecting an upcoming traffic signal at an intersection and a status of the upcoming traffic signal, identifying intersection data relating to the intersection with the upcoming traffic signal, and performing a vehicle control action on the vehicle at the intersection based on the cognitive state of the driver, the status of the upcoming traffic signal, and the intersection data.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a vehicle control method 100 according to an embodiment of the present invention;

FIG. 2 depicts a cloud-computing node 10 according to an embodiment of the present invention;

FIG. 3 depicts a cloud-computing environment 50 according to an embodiment of the present invention; and

FIG. 4 depicts abstraction model layers according to an embodiment of the present invention.

### DETAILED DESCRIPTION

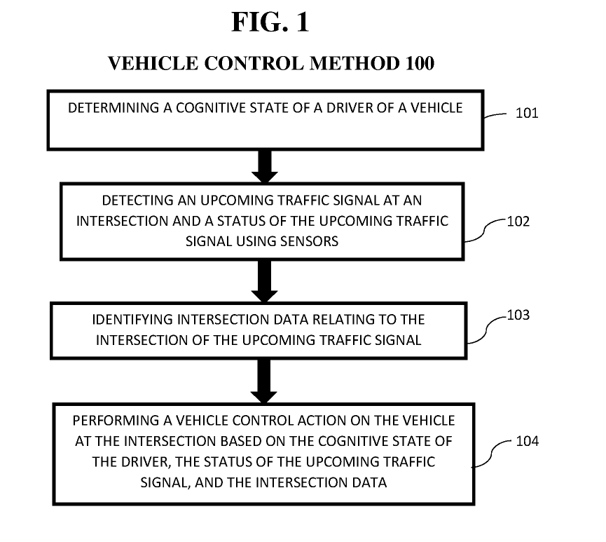

The invention will now be described with reference to FIGS. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity.

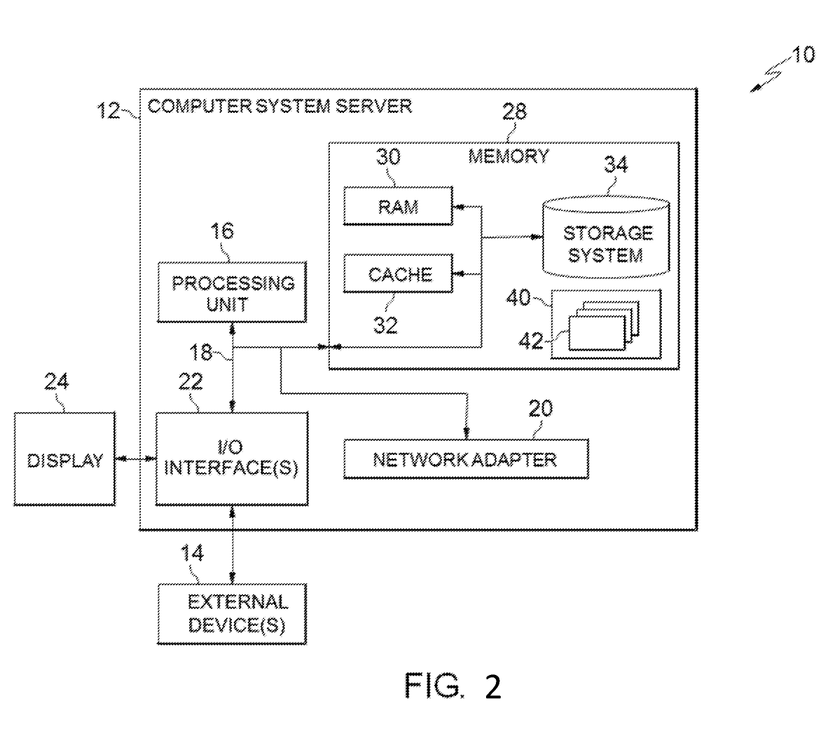

By way of introduction of the example depicted in FIG. 1, an embodiment of a vehicle control method 100 according to the present invention can include various steps for increasing the safety of driving and the more accurate determination of whether the vehicle should proceed through the intersection, or stop prior to entering the intersection. By way of introduction of the example depicted in FIG. 2, one or more computers of a computer system 12 according to an embodiment of the present invention can include a memory 28 having instructions stored in a storage system to perform the steps of FIG. 1.

Thus, a vehicle control method 100 according to an embodiment of the present invention may act in a more sophisticated, useful and cognitive manner, giving the impression of cognitive mental abilities and processes related to knowledge, attention, memory, judgment and evaluation, reasoning, and advanced computation. In other words, a “cognitive” system can be said to be one that possesses macro-scale properties—perception, goal-oriented behavior, learning/memory and actions generally recognized as cognitive.

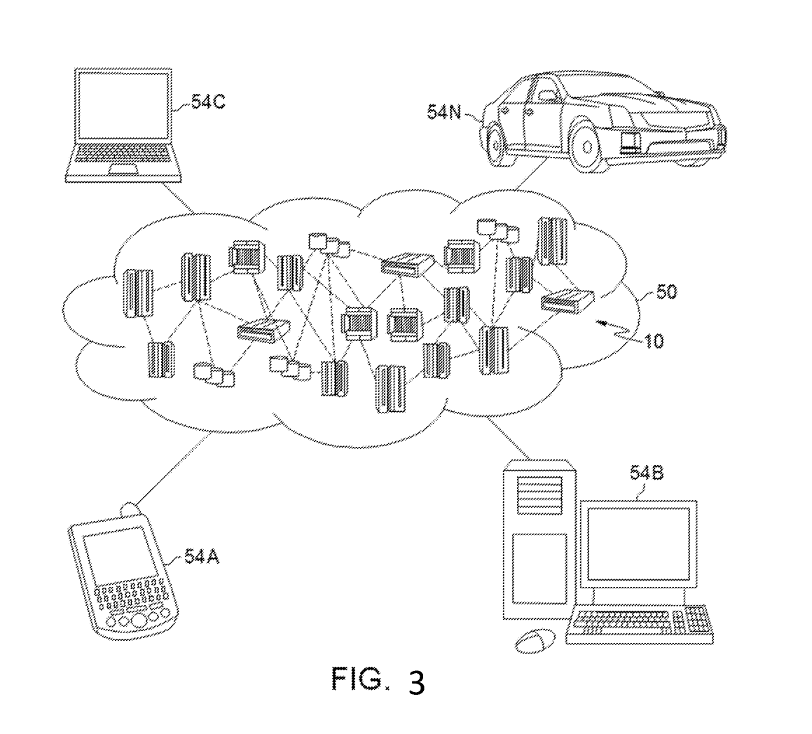

Although one or more embodiments may be implemented in a cloud environment 50 (see e.g., FIG. 3), it is nonetheless understood that the present invention can be implemented outside of the cloud environment.

In the description below, the colors of the traffic signal include “green” which refers to “go”, “yellow” which refers to “caution”, and “red” which refers to “stop”. The traffic signal changes colors from green indicating for the vehicle to travel through the intersection to yellow indicating for the vehicle to caution and slow at the traffic signal to red indicating for the vehicle to stop the traffic signal. Obviously, while the above convention is used in the United States and many other countries, other conventions can be used.

Referring now to FIG. 1, in step 101, a cognitive state of a driver of a vehicle is determined Driver's reaction times are slower for young and older drivers alike. The reaction time decreases as a young driver gains experience and increases as a mature driver ages. Additionally, peripheral vision decreases with age. Many people continue to drive cars when cognitively-impaired. This can be due to their age, sleep deprivation, effects of alcohol, drugs, medicine, distractions due to passengers in the car (e.g., pets, children, loud music, discussion with friends), underlying medical conditions, etc. Cell phone use, either hand-free, or hand-held, and especially texting while driving significantly affects the ability of drivers to pay attention and leads to longer reaction times. In step 101, various sensors such as a smartphone, a breathalyzer, Internet-of-Things-(IoT) enabled devices, cameras (i.e., image analytics), etc. can be used to determine the current cognitive state of a driver. For example, a smartphone being used by the driver to text might indicate that the current cognitive state of the driver is distracted. Alternatively, cameras in the vehicle and image analytics can determine if the driver is tired or focused on driving. Also, other factors, such as the reaction time of a driver or the analysis of the driving pattern can be included in the cognitive state assessment and determined from a database (i.e., storing values of the specific driver) and historical values (e.g., a particular reaction time for a type or class of driver) of all drivers.

It is noted that the cognitive state of the driver is a measure of the driver's behavior (e.g., whether he/she is currently braking, continuing at the same speed, or increasing speed) to in part be used to identify whether the vehicle should continue through the intersection or come to a stop.

In some embodiments, a user profile can be learned over time such that the cognitive state of the driver can be inferred through machine learning. For example, a time of day or a destination can be used to determine the cognitive state if the sensors continuously (or typically) determine a driver is distracted on their way to work. Or, a driver can input their reaction time if it is known that the driver's reaction time differs from a historical norm of their cohort of drivers (e.g., the driver has a better (or worse) reaction time than the average).

In step 102, an upcoming traffic signal at an intersection (or the like) and a status of the upcoming traffic signal are detected using sensors. For example, an on-board camera system in the vehicle can be used to determine if the traffic signal is green, red, or yellow. Also, a database of the signal timings (e.g., when a signal switches from yellow to red, determining how long a yellow light lasts, etc.) can be communicated with the method 100. That is, vehicular sensors (e.g. video, laser, radar, infrared, etc.) can be used to identify an upcoming traffic intersection and details of the traffic signal relating to that intersection including the illumination of a yellow (caution) light, the typical duration of the yellow (caution) light, the time remaining of the illumination of the yellow (caution) light, the distance to the beginning of the intersection and the distance to the far side of the intersection and whether cars are at or approaching the intersection in the orthogonal direction. It is noted that the status of the upcoming traffic signal refers to a color of the light and a timing of the changing of the light.

Further, some details relating to the above can be provided externally (i.e., from government servers, local records, the traffic signal itself, etc.) or learned over time.

In step 102, satellite positioning can also be utilized as a way to determine the car's current location in reference to the intersection with the stoplight. The time remaining for the illuminated light on the traffic signal to turn from yellow to red can be determined through signal communications with the traffic control device, or stored/acquired data in the car's onboard systems on the normal length of time of the illumination of a yellow light for a traffic control device on this particular road/in this area. Such can also be re-calibrated periodically based on updates from authorities controlling such infrastructure.

It is noted that if the traffic signals are obstructed from view (e.g., the traffic signals are covered with snow, or not visible due to rain or fog), beacons on the traffic lights can be used to determine the status.

In step 103, intersection data are identified relating to the intersection of the upcoming traffic signal. Intersection data can include, for example, a length of time between a light turning from yellow to red for the particular stoplight, the vehicle's current speed, the vehicle's trajectory (whether it will continue straight through the intersection or turn), other vehicles at the traffic signal (e.g., a vehicle in oncoming traffic attempting to make a left-hand turn across the intersection), a presence of pedestrians, a status of a vehicle behind the driver's vehicle (e.g., if stopping will cause the vehicle behind the driver to hit the driver's vehicle), etc.

In step 104, a vehicle control action is performed on the vehicle at the intersection based on (a combination of) the cognitive state of the driver, the status of the upcoming traffic signal, and the intersection data. The vehicle control action can include actions such as proceeding through the intersection (e.g., no action or an activation of the acceleration of the vehicle), stopping prior to entering the intersection (e.g., a brake control action), a warning light on the vehicle dash (e.g., a light indicating that the driver should accelerate or brake), etc.

That is, using the analysis of all the factors (or one factor), an appropriate course of action for the vehicle is performed to employ the driver-assisted capability of automatic braking, to warn the driver that he/she will not make it through the intersection prior to the light turning red (so that he/she can make his/her own determination of a course of action), or to allow the car and the driver's efforts to continue without any assistance or changes in course. In some circumstances, it might be safer to continue through a red light (e.g., if there is no traffic in the orthogonal direction) if aggressive braking might result in a rear-end collision with the vehicle directly behind.

For example, if the time to proceed through the intersection is greater than a safety threshold value and the current vehicle speed is less than a threshold value required to stop before the traffic signal while stopping the vehicle will not cause a vehicle behind the driver's vehicle to hit the driver's vehicle, a vehicle control action of automatic braking to stop the vehicle before the traffic signal can be performed.

In another example, if the vehicle behind the driver's vehicle is traveling at a high rate of speed indicating an imminent accident if the driver were to stop the vehicle at the traffic signal and it is detected that the upcoming traffic signal will remain yellow long enough for the driver's vehicle to proceed through the intersection safely, a vehicle control action of causing the driver's vehicle to accelerate (or proceed at the current velocity) through the intersection can be performed.

In some embodiments, “obstruction” of traffic lights can be assisted such as if a vehicle is behind a truck that obstructs the yellow light or the red light. Or, there may be trees or other structures or sunlight that may obstruct the driver's vision of the yellow light. The traffic light signal may employ beacons that send information over a short distance to the vehicles moving towards these lights. The vehicle receives this information and if it cannot visually identify the lights, it prioritizes the beacon information over the camera-based inputs.

In another embodiment, vehicles ahead inform other vehicles behind of one or more lanes within a distance (e.g., such as fifty feet) about the status of traffic lights based on their visual and other inputs. For example, vehicles can communicate between each other using an internet connectivity between mobile devices in the vehicles. That is, if a vehicle nearer to a light detects a light change, the vehicle can communicate to vehicles behind them within a range about the light change. The vehicle control action can be performed prior to the traffic signal to gradually increase the distance between the driver's vehicle and the vehicle either in front or behind, to avoid a potential accident.

Further, geolocation-based analytics with temporal parameters (such as geo-temporal analytics) may be used to determine if at a given intersection that the car is approaching is known to have long traffic stops, to have cars crossing the intersection when the traffic light is red or yellow, to have pedestrians or animals passing via the intersection, etc. Such analytics can be used by the car to ensure that it is taking a decision to stop or proceed at an intersection. When a car stops or proceeds, the analytics also determines the speed at which it should proceed, or how hard the brake should be applied. Moreover, the sensors on the car may decide when to put on brakes depending on the weather conditions, the snow accumulation, or rain, and the car capabilities in order to prevent it from causing minimum harm (risk-aware manner). The real-time risk to brake or not is also assessed.

Thus, in step 104, a risk “R” is calculated by determining a level of driver distraction or cognitive impairment (e.g., the cognitive state of the driver), and a difficulty “D” in stopping the vehicle within the required time to avoid running the red light or causing an accident at the intersection. The difficulty D may be determined by the road condition, weather condition, tires, age of brakes, etc. If either R or D exceeds a threshold value, a vehicle control action is performed on the vehicle at the intersection.

In some cases, it might determine that “super human” braking is required to stop the vehicle (e.g., an impossible braking force needs to be applied to stop the vehicle at the intersection). In such cases, and depending on the traffic behind and orthogonal to the direction of travel, it might determine that the safest action is to continue through the intersection without stopping even if it means traveling through a red light.

Therefore, steps 101-104 can allow a vehicle control action to compensate and assist a cognitively impaired driver when determining whether or not to proceed through an intersection. For example, the assessment of a driver's behavior and current cognitive state along with the assessment of a traffic signal and the car's details (e.g., speed, trajectory, distance to end of intersection, etc.) are used to determine the best course of action (i.e., whether to allow the driver to continue unimpeded, to send warning signals or alerts to the driver, or to employ an automatic braking mechanism to slow the car or to bring the car to a stop). That is, the driver's behavior includes whether he/she is maintaining speed or accelerating (as to proceed through the light), or is decelerating (as to stop). Steps 101-104 assess the maximum deceleration level for the car, to determine if he/she can stop prior to entering the intersection or if the car must supplement the deceleration through the auto-braking mechanism to ensure that the vehicle stops. Additionally, consideration of the driver's cognitive state (i.e., whether he/she is cognitively impaired, in cognitive decline, elderly, young, in distress, distracted, etc.) is provided.

In other embodiments, a driver profile can be learned over time to better help assist the driver. For example, a driver can always prefer to stop at intersections when the traffic signal is yellow. Thus, the vehicle control action can be taken while the light is green and the time to yellow is short such that the driver does not travel through a yellow light.

In some embodiments, the reaction time for a specific driver can be included as part of the intersection data when the driver exceeds a certain number of times going through a particular intersection. For example, a driver may go through the same intersection on the way to work and the driver specific data for this intersection can be used instead (or with) the cohort data of the intersection. In this manner, the data can be personalized more for specific users.

Further, accident data can be included as part of the intersection data and different safety factors can be included when determining the vehicle control action. For example, if a particular intersection has a very high accident rate when cars proceed through the intersection when the light is yellow, the vehicle control action performed is to stop the vehicle prior to the light regardless of other parameters so long as the vehicle can safely stop. Alternatively, if the traffic signal has a low historical accident rate, the ability to proceed through the light before the light turns red may be weighed highest to reduce traffic in the area since it is unlikely that a vehicle traveling through a yellow light will cause an accident.

Thus, the invention performs and considers a cognitive analysis of the driver status, the traffic signal status, and the intersection data. Preferences may be set or the driver can be allowed to decide what to do. As evident above, the system may override a user's preferences to ensure safety of the driver as well as those vehicles and persons around the driver.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 2, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing circuit, other peripherals, such as display 24, etc., and one or more components that facilitate interaction with computer system/server 12. Such communication can occur via Input/Output (I/O) interface 22, and/or any circuits (e.g., network card, modem, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

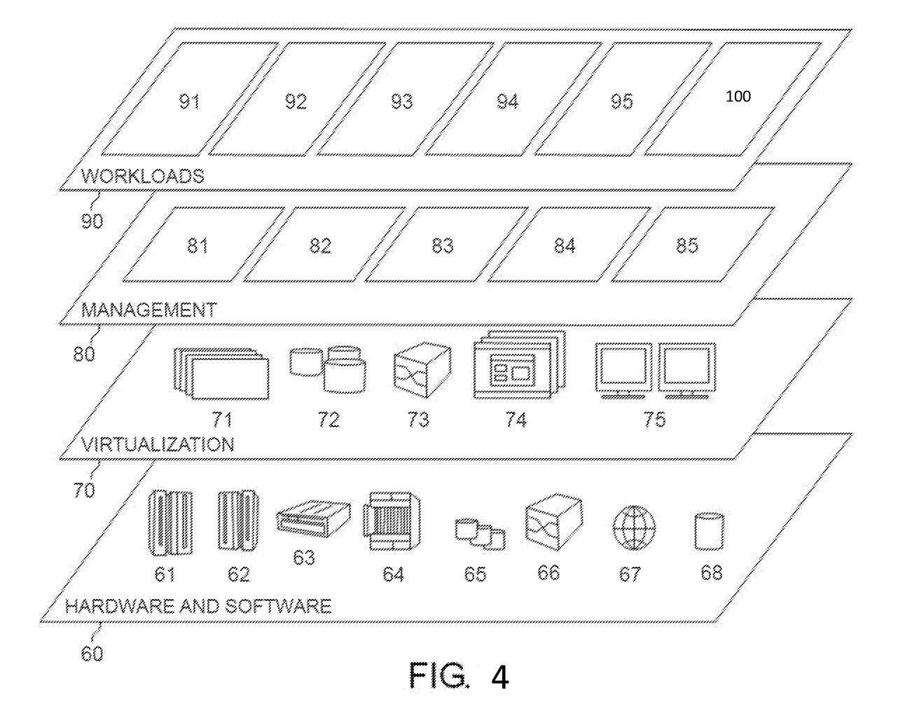

Referring now to FIG. 4, an exemplary set of functional abstraction layers provided by cloud computing environment 50 (FIG. 43) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and vehicle control method 100 in accordance with the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented vehicle control method, the method comprising:
determining a cognitive state of a driver of a vehicle;
detecting an upcoming traffic signal at an intersection and a status of the upcoming traffic signal;
identifying intersection data relating to the intersection with the upcoming traffic signal; and
performing a vehicle control action on the vehicle at the intersection based on the cognitive state of the driver, the status of the upcoming traffic signal, and the intersection data.

2. The computer-implemented method of claim 1, wherein the cognitive status of the driver comprises a measure of the driver's behavior and a likelihood that the driver can determine a correct action to take at the intersection.

3. The computer-implemented method of claim 1, wherein the status of the upcoming traffic signal includes a color of the traffic signal and a timing of a change from a first color to a second color.

4. The computer-implemented method of claim 1, wherein the cognitive status of the driver comprises a reaction time of the driver determined from at least one of historical values of a similar cohort of drivers and at least one previous value of the driver.

5. The computer-implemented method of claim 1, wherein the intersection data includes at least one of:
a length of time between the status turning from a first color to a second color;
a current speed of the vehicle;
a trajectory of the vehicle;
a status of other vehicles at the traffic signal;
a presence of a pedestrian in a vicinity of the traffic signal; and
a status of a second vehicle behind the vehicle.

6. The computer-implemented method of claim 1, wherein the vehicle control action comprises one of:
allowing the vehicle to proceed through the intersection;
stopping the vehicle prior to entering the intersection; and
displaying a warning light on the vehicle dash.

7. The computer-implemented method of claim 1, wherein, if the intersection data indicates that stopping the vehicle prior to the intersection will result in a second vehicle behind the vehicle impacting the vehicle, the performing performs an acceleration action as the vehicle control action to accelerate the vehicle through the traffic signal and the intersection.

8. The computer-implemented method of claim 1, wherein, if the cognitive state of the driver is determined as an impaired state, the performing performs a braking control action as the vehicle control action to stop the vehicle before the intersection.

9. The computer-implemented method of claim 1, wherein the vehicle control action is based on a weighted total of each of the cognitive state of the driver, the status of the upcoming traffic signal, and the intersection data where the performing performs a braking control as the vehicle control action to stop the vehicle when a risk of the weighted total is greater than a predetermined threshold.

10. The computer-implemented method of claim 1, wherein the intersection data includes an accident history value for the intersection, and
wherein the performing performs a braking control as the vehicle control action to stop the vehicle when the accident history value is greater than a safety threshold value.

11. The computer-implemented method of claim 1, embodied in a cloud-computing environment.

12. A computer program product for vehicle control, the computer program product comprising a computer-readable storage medium having program instructions embodied therewith, the program instructions executable by a computer to cause the computer to perform:
determining a cognitive state of a driver of a vehicle;
detecting an upcoming traffic signal at an intersection and a status of the upcoming traffic signal;
identifying intersection data relating to the intersection with the upcoming traffic signal; and
performing a vehicle control action on the vehicle at the intersection based on the cognitive state of the driver, the status of the upcoming traffic signal, and the intersection data.

13. The computer program product of claim 12, wherein the cognitive status of the driver comprises a measure of the driver's behavior and a likelihood that the driver can determine a correct action to take at the intersection.

14. The computer program product of claim 12, wherein the status of the upcoming traffic signal includes a color of the traffic signal and a timing of a change from a first color to a second color.

15. The computer program product of claim 12, wherein the cognitive status of the driver comprises a reaction time of the driver determined from at least one of historical values of a similar cohort of drivers and at least one previous value of the driver.

16. The computer program product of claim 12, wherein the intersection data includes at least one of:
a length of time between the status turning from a first color to a second color;
a current speed of the vehicle;
a trajectory of the vehicle;
a status of other vehicles at the traffic signal;
a presence of a pedestrian in a vicinity of the traffic signal; and
a status of a second vehicle behind the vehicle.

17. The computer program product of claim 12, wherein the vehicle control action comprises one of:
allowing the vehicle to proceed through the intersection;
stopping the vehicle prior to entering the intersection; and
displaying a warning light on the vehicle dash.

18. The computer program product of claim 12, wherein the vehicle control action is based on a weighted total of each of the cognitive state of the driver, the status of the upcoming traffic signal, and the intersection data where the performing performs a braking control as the vehicle control action to stop the vehicle when a risk of the weighted total is greater than a predetermined threshold.

19. A vehicle control system, said system comprising:
a processor; and
a memory, the memory storing instructions to cause the processor to perform:
determining a cognitive state of a driver of a vehicle;
detecting an upcoming traffic signal at an intersection and a status of the upcoming traffic signal;
identifying intersection data relating to the intersection with the upcoming traffic signal; and
performing a vehicle control action on the vehicle at the intersection based on the cognitive state of the driver, the status of the upcoming traffic signal, and the intersection data.

20. The system of claim 19, embodied in a cloud-computing environment.
